(19) United States
(12) Patent Application Publication
(10) Pub. No.: US 2015/0187188 A1
(43) Pub. Date: Jul. 2, 2015

(54) COMMUNICATIONS USING TACTILE STIMULI ON WEARABLE DEVICES

(71) Applicant: Aza Raskin, San Francisco, CA (US)

(72) Inventor: Aza Raskin, San Francisco, CA (US)

(73) Assignee: AliphCom, San Francisco, CA (US)

(21) Appl. No.: 14/144,512

(22) Filed: Dec. 30, 2013

(51) Int. Cl. G08B 6/00

(52) U.S. Cl. CPC G08B 6/00

(57) ABSTRACT

Techniques for communicating using tactile stimuli on wearable devices are disclosed. In some examples, a signal representing a state of a user of a first wearable device is received at a second wearable device. A control signal is generated based on the state, and the control signal is configured to generate a tactile stimulus. Transmission of the tactile stimulus to a region exterior to the second wearable device is caused. In some examples, a signal representing a first attribute of a first force from sensors of a first wearable device is received at a second wearable device. A control signal is generated based on the first attribute, and the control signal is configured to generate a second force that has a second attribute that is substantially similar to the first attribute. Transmission of the second force to a region external to the second wearable device is caused.

### FIELD

Various embodiments relate generally to wearable electrical and electronic hardware, computer software, human-computing interfaces, wired and wireless network communications, data processing, and computing devices. More specifically, disclosed are techniques for communicating using tactile stimuli on wearable devices.

### BACKGROUND

With the advent of computing devices in smaller personal and/or portable form factors and an increasing number of applications (i.e., computer and Internet software or programs) for different uses, mobile communication has become increasingly popular. Conventional devices generally allow communication using visual and audio signals.

Thus, what is needed is a solution for communicating using tactile stimuli on wearable devices.

### BRIEF DESCRIPTION OF THE DRAWINGS

Various embodiments or examples (“examples”) are disclosed in the following detailed description and the accompanying drawings:

FIG. 1 illustrates an exemplary wearable device with a tactile manager in some applications, according to some examples;

FIG. 2 illustrates a block diagram for an exemplary wearable device with a tactile manager, according to some examples;

FIG. 3 illustrates exemplary tactile sources for use on an exemplary wearable device with a tactile manager, according to some examples;

FIG. 4A illustrates exemplary tactile stimuli provided on an exemplary wearable device with a tactile manager, according to some examples;

FIG. 4B illustrates another exemplary tactile stimuli provided on an exemplary wearable device with a tactile manager, according to some examples;

FIG. 5 illustrates exemplary sensors for use on an exemplary transmitting wearable device, according to some examples;

FIG. 6 illustrates an exemplary process for a tactile manager, according to some examples;

FIG. 7 illustrates another exemplary process for a tactile manager, according to some examples;

FIG. 8 illustrates a block diagram for an exemplary wearable device with a tactile manager, according to some examples; and

FIG. 9 illustrates an exemplary computer system suitable for use with a tactile manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

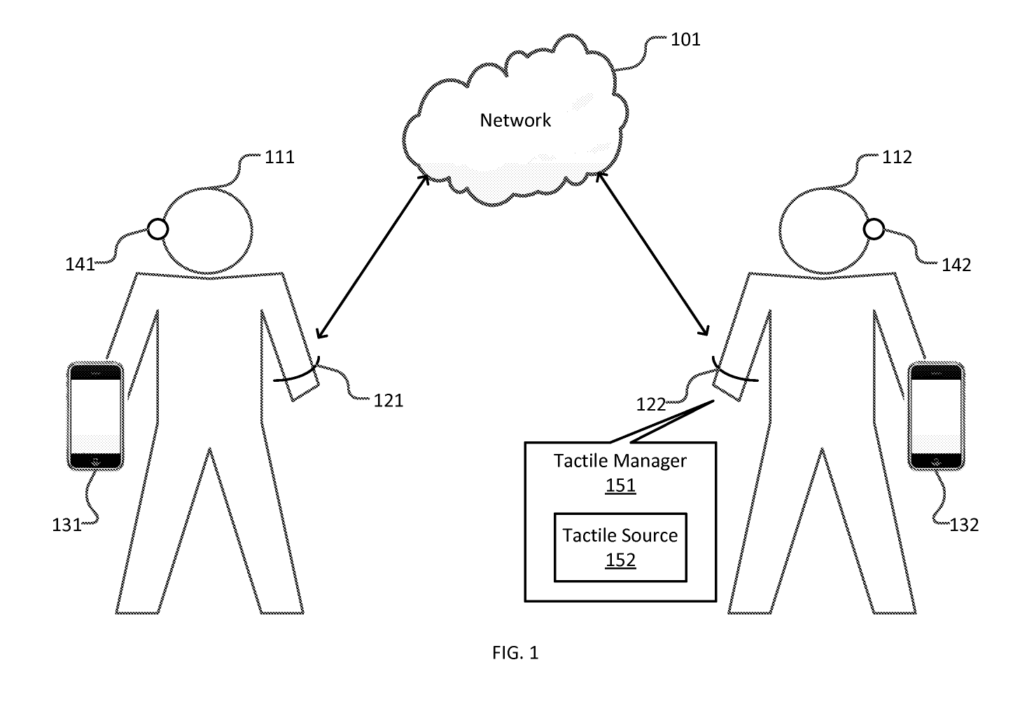

FIG. 1 illustrates an exemplary wearable device with a tactile manager in some applications, according to some examples. As shown, FIG. 1 includes a network 101, users 111-112, wearable devices 121-122, 131-132 and 141-142, a tactile manager 151 and a tactile source 152. Network 101 may be a local or global network, using wired or wireless communications protocols (e.g., IEEE 802.11a/b/g/n (WiFi), WiMax, ANT™, ZigBee®, Bluetooth®, Near Field Communications (NFC), 3G, 4G, telecommunications, internet protocols, and others). Still, other networks may be used. User 111 may be the transmitting user or the first user. User 112 may be the receiving user or the second user. User 112 may be a significant other or friend of user 111. User 111 and user 112 may also have no pre-existing relationship. Wearable devices 121-122, 131-132 and 141-142 may be worn on or around an arm, leg, ear, or other bodily appendage or feature, or may be portable or carried in a user's hand, pocket, bag or other carrying case. “Wearing” and “carrying” are used interchangeably to refer to a wearable device being worn or carried. As an example, wearable devices 121 are data-capable strapbands (or data-capable bands), wearable devices 131-132 are smartphones, and wearable device 141-142 are headsets. Other wearable devices such as a watch, data-capable eyewear, cell phone, tablet, laptop or other computing device may be used. Wearable devices 121, 131 and 141 may be transmitting wearable devices or first wearable devices, and wearable devices 122, 132 and 142 may be receiving wearable devices or second wearable devices. First wearable devices 121, 131 and 141 may communicate or exchange data with second wearable devices 122, 132 and 142 through network 101. First wearable devices 121, 131 and 141 may also communicate with second wearable devices 122, 132 and 142 directly or through a hub, server or other intermediary. Different types of wearable devices may communicate with each other over network 101, e.g., strapband 121 may transmit data to headset 142 over network 101.

In one example, as shown, wearable device 122 has tactile manager 151 and tactile source 152. Any of wearable devices 121-122, 131-132 and 141-142 may have a tactile manager and a tactile source. Here, tactile manager 151 coupled to second wearable device 122 may receive a signal representing a state of user 111 wearing first wearable device 121 from first wearable device 121. Tactile manager 151 may reside locally on second wearable device 122 or may be remote from second wearable device 122. A state may be a condition of user 111 detected or measured by one or more sensors coupled to first wearable device 121 that is detectable without intentionality on the part of user 111 while user 111 is wearing the first wearable device 121. A state may be detectable or measureable without user 111 intending to input or enter the state into first wearable device 121. Examples include the heart rate of user 111, the skin temperature of user 111, ambient temperature of the location of user 111, the location of user 111 relative to user 112, the mood or emotional state of user 111 (e.g., sad, happy, etc.), the activity of user 111 (e.g., running, resting, etc.) and the like. A state may also be a combination of conditions, e.g., a state may be the activity of running and a temperature above 100 degrees Fahrenheit. In some examples, a state may trigger or initiate a transmission of the state (or another state) from first wearable device 121 to be received by second wearable device 122. For example, the state of first user 111 may be a heart rate above a threshold level, e.g., 100 beats per minute (bpm). This state may trigger the transmission of the heart rate, which is received by second wearable device 122. In other examples, a command or other instruction may initiate or cause a transmission of a state from first wearable device 121 to second wearable device 122. More details on sensors used for detecting the state are described below.

Tactile manager 151 may generate a control signal based on the state of user 111, received by second wearable device 121. The control signal may be configured to generate a tactile stimulus on second wearable device 121. A tactile stimulus may be a stimulus or a signal having an attribute that is measured or perceived by the sense of touch, sense of heat (or cold), or otherwise by the skin. Examples include force, pain, temperature, and the like. A tactile stimulus may be composed of a stimulus pattern, e.g., two hard squeezes and one light squeeze, a long buzz followed by a short buzz, a buzz on the right followed by a buzz on the left, etc. The control signal is used to control, instruct, command or manage tactile source 152.

Tactile source 152 may cause the tactile stimulus to be transmitted to a region exterior to second wearable device 122. A region exterior to a wearable device may be a region or area that is exterior, outside or external to the molding, covering or surface of the wearable device. For example, tactile source 152 may generate a vibration to a region exterior to wearable device 122. Tactile source 152 may generate a compression to a region exterior to wearable device 122. The tactile stimulus may represent a communication from first wearable device 121 to second wearable device 122. For example, first wearable device 121 may communicate or transmit to second wearable device 122 the heart rate of first user 111. The transmission of the heart rate may generate an emotional connection between first user 111 and second user 112. In some examples, the tactile stimulus may be a simulation of the state of first user 111. A simulation may be a tactile stimulus that imitates or is substantially a reproduction of the state of first user 111. For example, a tactile stimulus simulating the heart rate of first user 111, may be, e.g., a series of compressions, or a pulsation, at the heart rate of first user 111. As another example, the state of first user 111 may be an ambient temperature above 100 degrees Fahrenheit. The state may trigger a transmission of the state, which is received by second wearable device 122. A control signal configured to provide a tactile stimulus is generated based on the state received. The tactile stimulus may be a simulation of the high temperature experienced by first user 111, e.g., a heating of a heating element on second wearable device 122. Hence first wearable device 121 may communicate to second wearable device 122 that the first wearable device 121 has detected a high temperature.

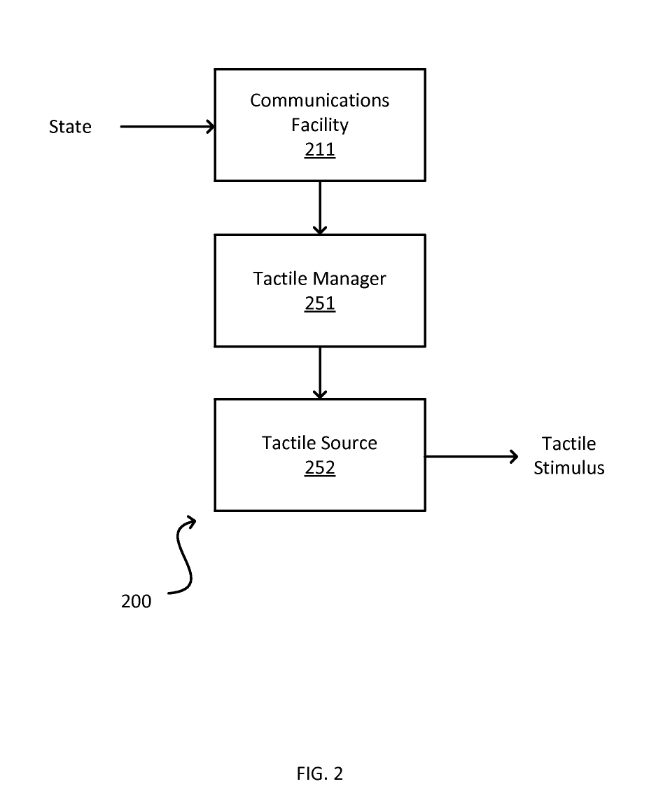

FIG. 2 illustrates a block diagram for an exemplary wearable device with a tactile manager, according to some examples. As shown, FIG. 2 includes a communications facility 211, a tactile manager 251 and a tactile source 252 of a second wearable device 200. In one example, as shown, communications facility 211 may receive a signal representing a state of a first user of a first wearable device (not shown). Communications facility 211 may transmit and receive data over a global or private network, using wired or wireless communication protocols (e.g., IEEE 802.11a/b/g/n (WiFi), WiMax, ANT™, ZigBee®, Bluetooth®, Near Field Communications (NFC), 3G, 4G, telecommunications, internet protocols, and others). Communications facility 211 may directly communicate with the first wearable device, or may communicate with the first wearable using a hub, server or other intermediary. Still, other methods of communication are possible.

Tactile manager 251 may generate a control signal based on the state. The control signal may be configured to generate a tactile stimulus on the second wearable device 200. Tactile source 252 may cause the tactile stimulus to be transmitted to a region exterior to the second wearable device 200. As described above, wearable device 200 may be a band, smartphone, headset or other device, and a tactile stimulus may be provided by any wearable device 200. For example, a tactile stimulus on a band may be a compressive force going from the circumference of the band to the center of the circular shape formed by the band. A user wearing the band on her arm may feel that her skin around which the band is worn is compressed by the band. As another example, a tactile stimulus on a headset may be a pressure going outward from a center of the headset (e.g., the headset may have an inflatable part that is being inflated). A user wearing the headset on his ear may feel that his skin around which the headset is worn is compressed by the headset. As another example, a tactile stimulus may be a vibratory pattern on a smartphone. The vibratory pattern may be generated by multiple motors located on the smartphone. A user carrying the smartphone in her hand may feel the vibratory pattern. As another example, a tactile stimulus may be a heating of a heating element on a laptop. A user carrying the laptop in a backpack on her back may feel a temperature change on her back. Still, other tactile stimuli may be generated on other wearable devices, and the examples above are not limiting. More details on the tactile source are described below.

In another example, communications facility 211 may receive a signal representing a first attribute of a first force exerted on a first wearable device from the first wearable device. The first force may be sensed or detected by one or more sensors associated with the first wearable device. A force may be a pressure exerted on an object, such as brushing, compression, squeezing, vibration, buzzing, and the like. A force is a type of tactile stimulus, as a force is a stimulus or attribute that is perceived by the skin. A force may be composed of a pressure pattern, such as a long squeeze and a short squeeze, two buzzes, etc. An attribute of a force may be a feature of the force or pressure, such as intensity, direction, duration, and the like. For example, a brushing may have a small intensity, a direction going from left to right, and a long duration. A squeezing may have a large intensity, a direction going radially inward from a circumference or perimeter, and a long duration. A vibration may have a medium intensity, random direction, and a short duration, being repeated over a time period.

Tactile manager 251 may generate a control signal based on the first attribute of the first force. The control signal may be configured to generate a second force on the second wearable device, with the second force having a second attribute that is substantially similar to the first attribute. Tactile source 252 may cause the second force to be transmitted to a region external to the second wearable device. In some examples, the first force and the second force may be used for communication between the first wearable device and the second wearable device. In some examples, the second force may be a simulation of the first force. A simulation may be an imitation or a substantial reproduction of the first force. For example, the first force exerted on the first wearable device may be a compression. The second force on the second wearable device may also be a compression, a simulation of the compression exerted on the first wearable device. The compression may represent a “virtual hug” transmitted from the first user to the second user. Communication or transmission of a “virtual hug” may generate an emotional connection between the first user and the second user.

As another example, the directions of the first force and the second force may be substantially similar if they are both going radially inward or both going radially outward. For example, the first force on a first strapband may be a squeeze, going radially inward. Then the second force on a second strapband may also go radially inward. A second user wearing the second strapband on her arm would sense a squeeze around her arm. As another example, the directions of the first force and the second force may be substantially similar if they are within the same sector. For example, a force that is 0 to 90 degrees from the surface of the wearable device may be “sector 1,” 91 to 180 degrees may be “sector 2,” 181 to 270 degrees may be “sector 3,” and 271 to 360 degrees may be “sector 4.” In one example, the first force makes a 50-degree angle with the surface of the first wearable device, considered as “sector 1.” The second force may then be in “sector 1” with respect to the second wearable device, e.g., 0 to 90 degrees from the surface of the second wearable device. As another example, the intensities of the first force and the second force may be the same magnitude. As another example, the intensities of the first force and the second force may be substantially similar based on a ranking of intensities. For example, a force of 0.1 lbs to 1 lbs may be ranked as “light,” a force of 1.1 lbs to 1.5 lbs may be ranked as “medium,” and a force of 1.6 lbs to 2.0 lbs may be ranked as “heavy.” In one example, the first force may have an intensity of 1.7 lbs, considered as “heavy.” The second force may then have a “heavy” intensity, which may be an intensity between 1.6 lbs and 2.0 lbs, or another range. The numerical range of the force corresponding to a “medium” intensity on the first wearable device may be the same as or different from the numerical range of the force corresponding to a “medium” intensity on the second wearable device. As another example, the durations of the first force and the second force may be the same period of time. As another example, the durations of the first force and the second force may be substantially similar based on a ranking of durations. For example, a duration of 0.1 s to 0.5 s may be ranked “short,” a duration of 0.6 s to 1 s may be ranked “medium,” and a duration of 1.1 s to 1.5 s may be ranked “long.” In one example, the first force may have a duration of 0.8 s. The second force may then have a “medium” duration, which may be between 0.6 s to 1 s, or another range. Other ranges may be used for the rankings, and different numbers of rankings may be used. Other attributes of the first force and the second force may be used.

Further, the second attribute of the second force may be substantially similar to a first attribute of a portion of the first force or to at least one attribute of a plurality attributes of the first force. For example, the first force may be a pressure pattern composed of a compression sustained for 0.3 s followed by a compression sustained for 0.8 s. Here, the first force may be considered to have two portions, one having a duration of 0.3 s, considered “short,” and another having a duration of 0.8 s, considered “medium.” The second force may have an attribute similar to at least one portion or at least one attribute, e.g., the second force may be one compression of a “short” duration. In another example, the second force may have both attributes, e.g., the second force may be a pressure pattern composed of a compression of a “short” duration followed by a compression of a “medium” duration. Other pressure patterns and other segmentations of the portions of a force may be used.

In one embodiment, a user interface coupled to the second wearable device may provide a visual, audio or other presentation or message, in addition to the tactile stimulus or force, based on the control signal generated based on the state of the first user or the force exerted on the first wearable device. The user interface may be any device that transmits or exchanges information between the user and the wearable device. The user interface may be located locally on or remotely from the wearable device. For example, a screen on the second wearable device may state, “You have received a virtual hug from your spouse!” As another example, a screen of a computer that is data communication with the second wearable device may state, “Your friend hugged you,” and a speaker of the computer may play a happy tune.

In one embodiment, the second wearable device may further transmit a signal to the first wearable device, the signal being configured to provide a prompt on the first wearable device. A prompt may be a reminder, alert or other message to the first user to send a “virtual hug” or other tactile stimulus to the second user. The prompt may be provided on a user interface coupled to the first wearable device. As described above, the user interface may be any device that transmits or exchanges information between the user and the wearable device. The user interface may be located locally on or remotely from the wearable device. For example, the user interface may a screen on the wearable device, which may visually display a message prompting the first user to send a tactile stimulus or force to the second user. As another example, the user interface may provide an audio message, an audio alarm, a blinking LED light, a vibration from a motor or other signals to the first user. As another example, the user interface may be a screen on a smartphone or laptop in communication with a wearable strapband. The screen may provide a prompt message, and the strapband may detect a state of the first user (e.g., a heartbeat of the first user), and the strapband may transmit data representing the state to a second wearable device.

The second wearable device may determine whether to transmit a signal to prompt the first user based on one or more criteria. The one or more criteria may be stored in a memory or database local or remote to the second wearable device. The criteria may be related to the state of the second user (e.g., whether he is happy, sad, exercising, resting, has a high heart rate, is feeling hot or cold, etc.). The state of the second user may be measured, detected or perceived by one or more sensors coupled to the second wearable device. More details on the sensors are described below.

In one example, the criteria are that the heart rate is low, there activity level is low, and the sound level is low. These criteria may represent or indicate that the second user is in a depressed or unhappy state, or in another state desiring an emotional connection with the first user. When sensors coupled to the second wearable device detect that the criteria has been matched, the second wearable device may transmit or send a signal to the first wearable device, the signal configured to provide a prompt on the first wearable device. The prompt may alert the first user that the second user is in a depressed state, needing a “virtual hug.” The prompt may be provided on a screen of a computer in data communication with the first wearable device. After receiving the prompt, the first user may squeeze the first wearable device to send a “virtual hug.” Still, other criteria and states may be used. Other types of prompts may be sent to the first wearable device, and the first user may be in another state or provide another force on the first wearable device.

In one embodiment, the second wearable device may be set to a mode in which the second wearable device does not generate tactile stimuli based on communications or data sent from the first wearable device. This mode may be called a “Do Not Disturb mode” or “Silent mode,” during which the second user does not wish to be disturbed. If the second wearable device receives a signal representing a state of the first user during a Do Not Disturb mode, a tactile stimulus will not be generated on the second wearable device. The first user may receive a message stating that the second user is in a Do Not Disturb mode.

A Do Not Disturb mode may be set on the second wearable device manually by the second user or automatically by the second wearable device based on one or more criteria. The one or more criteria may be stored in a memory local or remote to the second wearable device. The criteria may be related to the state of the second user (e.g., whether he is happy, sad, exercising, resting, has a high heart rate, is feeling hot or cold, etc.). The state of the second user may be measured, detected or perceived by one or more sensors coupled to the second wearable device. More details on sensors for detecting the state of the second user are described below.

For example, the criteria may be that the current time is 9:30 a.m., the second user is located in his office, and the noise level is medium. These criteria may represent or indicate that the second user is attending a meeting. When sensors of the second wearable device detect that the criteria are met, the second wearable device may be automatically set to a Do Not Disturb mode.

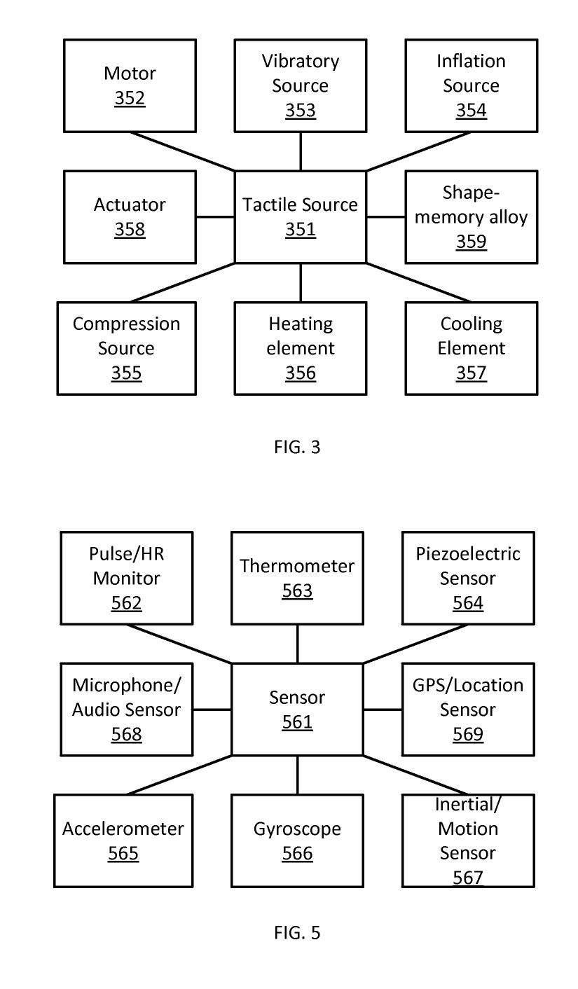

FIG. 3 illustrates exemplary tactile sources for use on an exemplary wearable device with a tactile manager, according to some examples. As shown, tactile source 351 may be a motor 352, a vibratory source 353, an inflation source 354, a compression source 355, a heating element 356, a cooling element 357, an actuator 358, and a shape-memory alloy 359. A tactile source may be a device that produces, generates or provides one or more tactile stimuli (e.g., a force, heating, vibration, etc.). Other devices may be used, and these examples are not limiting. These devices may be used independently or in combination to produce a tactile stimulus or force on the second wearable device. More than one of each device (e.g., two motors) may be used to produce a tactile stimulus or force. For example, motor 352, vibratory source 353 and/or actuator 358 may be used to provide a vibration on the second wearable device. As another example, inflation source 354 may inflate the wearable device or a portion of the wearable device. Shape-memory allow 359 may remember one or more shapes and hold or return to a shape based on a temperature or other factor. Inflation source 354, shape-memory allow 359 and/or compression source 355 may be used to provide a tightening, compression or squeezing on the second wearable device. As another example, heating element 356 and cooling element 357 may be used to control the temperature of the wearable device or a portion of the wearable device.

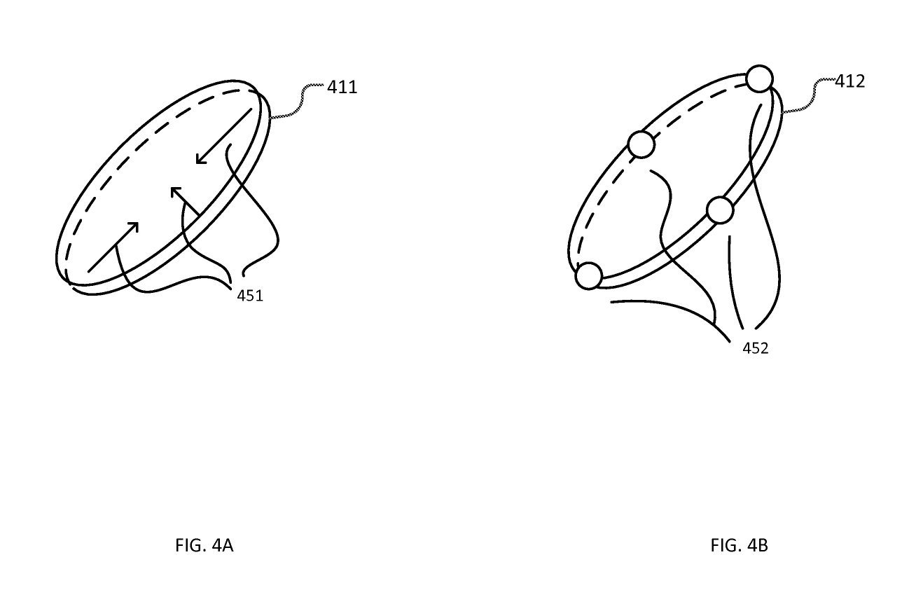

FIGS. 4A and 4B illustrate exemplary tactile stimuli provided on an exemplary wearable device with a tactile manager, according to some examples. As shown, FIG. 4A includes wearable device 411 and forces 451, and FIG. 4B includes wearable device 412 and motors 452.

For example, as described above, the tactile stimulus provided on the second wearable device may be a simulation of a heartbeat of the first user, e.g., a series of compressions provided at the rate of the heartbeat of the first user. A compression may produce forces 451, going inward from the circumference of wearable device 411. Forces 451 may be produced by one or more inflation sources, shape-memory alloys, compression sources or other devices. A compression may produce additional forces (not shown) going inward from the circumference. A compression may also be two forces, one going inward from the left of the wearable device and another going inward from the right of the wearable device. A compression may also be one force, one pressure going inward from one point or area on the circumference. As shown, forces 451 are being transmitted to a region exterior to wearable device 411. Other pressure patterns may also be used.

For example, as described above, the state of the first user may be a location of the first wearable device with respect to the second wearable device. The tactile stimulus produced on the second wearable device may be a vibratory pattern indicating the position of the first wearable device. For example, a vibratory pattern may be produced to a region exterior to wearable device 412 by motors 452. One of the motors 452 closest to the first wearable device may vibrate while the others remain still. For example, the first wearable device may be to the right of the second wearable. Then the rightmost motor of motors 452 may vibrate while the other three remain still. Other combinations of motors and tactile sources may be used, and other vibratory patterns may be used.

A user wearing or carrying wearable devices 411-412 would sense the second force on a skin or tissue touching or in connection with wearable devices 411-412. For example, a user wearing wearable device 411 around her arm would sense a squeeze around her arm (or part of her arm) due to forces 451. A user wearing wearable device 412 around her arm would sense a vibration on her arm (or part of her arm) due to motors 452.

FIG. 5 illustrates exemplary sensors for use on an exemplary transmitting wearable device, according to some examples. As shown, sensor 561 may be a pulse/heart rate monitor 562, a thermometer 563, a piezoelectric sensor 564, an accelerometer 565, a gyroscope 566, an inertial sensor 567, a microphone/audio sensor 568, and a GPS/location sensor 569. A sensor may be a device that detects, senses or perceives one or more sensory inputs. Other devices may be used, and these examples are not limiting. These devices may be used independently or in combination to sense or detect sensory inputs. More than one of each device (e.g., two thermometers) may be used to detect a sensory input. One or more sensors may be coupled to the first wearable device and/or the second wearable device. Sensors coupled to a first wearable device may be used to detect a state of a first user, or a gesture made by the first user with the first wearable device. The state detected by the sensors may be received by a second wearable device. The state or the gesture may also trigger a transmission of a state or a first attribute of a first force, which is received by a second wearable device. Sensors coupled to a second wearable device may be used to detect a state of a second user. The state may be used to determine whether to send or transmit a signal configured to provide a prompt on a first wearable device, or whether to set the second wearable device in a Do Not Disturb mode.

For example, pulse/heart rate monitor 562 may detect electrical activity of a user's heart, or a heart rate of the user. Pulse/heart rate monitor 562 on a first wearable device may detect a heart rate of a first user, and transmit this to a second wearable device. Pulse/heart rate monitor 562 on a first wearable device may also detect that the heart rate of the first user is above 100 beats per minute (bpm), which may trigger the first wearable device to transmit a state (e.g., the heart rate) to the second wearable device. As another example, pulse/heart rate monitor 562 on a second wearable device may detect a heart rate of a second user, and based on the heart rate of the second user determine whether to send a signal configured to provide a prompt on a first wearable device, or whether to set the second wearable device to a Do Not Disturb mode. For example, thermometer 563 may detect the skin temperature of the user and/or the ambient temperature of the user. Two thermometers may be used together, one detecting skin temperature and the other detecting ambient temperature. For example, piezoelectric sensor 564 may be a device that uses piezoelectric effect to measure changes in pressure, acceleration, strain or force. Piezoelectric sensor 564 may be made of piezoelectric ceramics, single crystal materials or other materials. For example, piezoelectric sensor 564 on a first wearable device may sense a force, compression or squeeze exerted on the first wearable device. Piezoelectric sensor 564 may be used to detect a “virtual hug” or a compression on a first wearable device, to be received by a second wearable device. Piezoelectric sensor 564 may be used to detect attributes of a force, e.g., intensity, direction, duration, etc. For example, microphone/audio sensor 568 may sense the voice of a user or the ambient noise or sound. For example, global positioning system (“GPS”)/location sensor 569 may sense a location of a wearable device. GPS/location sensor 569 may be used to obtain coordinates of the geographic location of a wearable device using, for example, various types of signals transmitted by civilian and/or military satellite constellations in low, medium, or high earth orbit (e.g., “LEO,” “MEO,” or “GEO”). Differential GPS algorithms may also be implemented with GPS/location sensor 569, which may be used to generate more precise or accurate coordinates. GPS/locations sensor 569 may also be used to determine a location within a cellular or micro-cellular network, which may or may not use GPS or other satellite constellations for fixing a position. For example, a location of a first wearable device with respect to a second wearable device may be determined by using a GPS/location sensor on the first wearable device to determine the geographic location of the first wearable device, and another GPS/location sensor on the second wearable device to determine the geographic location of the second wearable device, and then comparing the two geographic locations.

Accelerometer 565, gyroscope 566 and/or inertial/motion sensor 567 may be used to sense motion. Piezoelectric sensor 564 may also be used to detect motion or acceleration. For example, accelerometer 565 on a first wearable device may be used to detect a gesture made by a first user wearing the first wearable device. The gesture may be a specific combination of movements (e.g., moving wrist up and down two times, twisting wrist clockwise and moving wrist up, etc.) that are pre-defined or installed on the first wearable device, or are manually defined or created by the first user. The specific combination of movements may compose one or more criteria of a gesture, which are stored in a memory local or remote to the wearable device. The gesture may be configured to trigger or initiate a transmission of a state of a first user from a first wearable device to a second wearable device. For example, a first wearable device may also detect a state of the first user, e.g., the first user's heart rate. The first wearable device may also detect a gesture made by the first user while wearing the first wearable device. The gesture triggers the state (e.g., the first user's heart rate) to be transmitted, and the state is received by the second wearable device. A control signal is generated based on the state. The control signal is configured to produce a tactile stimulus on the second wearable device, e.g., a compression matching the rate of the first user's heartbeat. As another example, accelerometer 565 on a second wearable device may be used to detect an activity or motion level of a second user wearing the second wearable device. Based on the activity level, the second wearable device may determine whether to transmit a signal configured to provide a prompt on a first wearable device. Still, other sensors may be used and the above-listed sensors are not limiting. Further, one or more sensors may be local or remote, or internal or external to the first wearable device or the second wearable device. A local sensor may be a sensor that is fabricated, manufactured, installed, integrated or otherwise implemented with a wearable device (e.g., wearable devices 121-122, 131-132 and 141-142 in FIG. 1). A remote sensor may be in data communication with the wearable device directly or indirectly (e.g., through a hub, network, intermediary, etc.), such as, an accelerometer on another wearable device (e.g., an accelerometer on wearable device 142 may be remote from wearable device 122), a keyboard on a laptop or other distributed sensors.

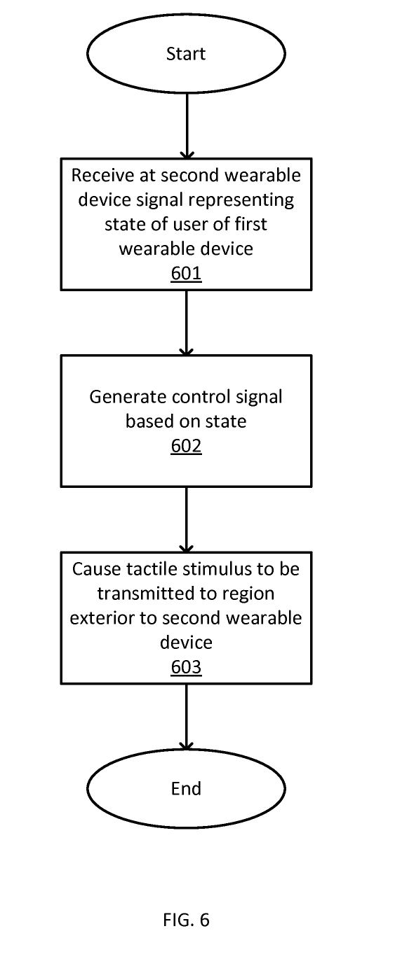

FIG. 6 illustrates an exemplary process for a tactile manager, according to some examples. At 601, a signal representing a state of a user of a first wearable device is received at a second wearable device. As described above, a state may be a condition of the user detected, measured or perceived by sensors or other devices coupled to the first wearable device that is detectable while the user is wearing the first wearable device even if the user has no intention of entering or inputting the state into the first wearable device. The user's intention may not be necessary for the detection of the state. At 602, a control signal is generated based on the state. The control signal may be configured to provide a tactile stimulus on the second wearable device. At 603, a tactile stimulus is initiated and is transmitted to a region exterior to the second wearable device. A tactile stimulus may be a force, vibration, heating, cooling or other stimulus. A tactile stimulus may be a simulation of the state. For example, the state may be a temperature of the first user, and the tactile stimulus may be a substantially similar temperature on the second wearable device.

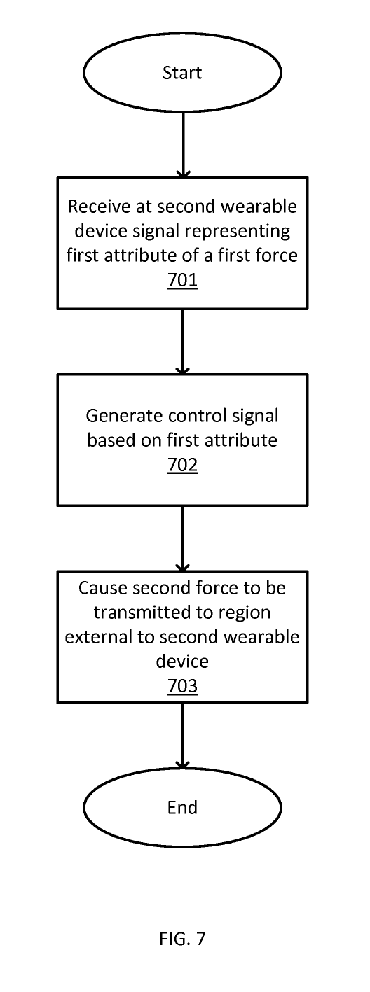

FIG. 7 illustrates another exemplary process for a tactile manager, according to some examples. At 701, a signal representing a first attribute of a first force is received at a second wearable device. The first force may be a force exerted on a first wearable device. The first force may be detected or measured by one or more sensors coupled to the first wearable device. A first attribute of the first force may be associated with the intensity, duration or direction of the first force. The first attribute may also be another attribute or feature of the first force. At 702, a control signal is generated based on the first attribute. The control signal may be configured to provide a second force on the second wearable device. At 703, a second force is initiated and is transmitted to a region exterior to the second wearable device. The second force may have a second attribute, which is substantially similar to the first attribute. For example, the first attribute may be a “medium” intensity, and the second attribute may also be a “medium” intensity.

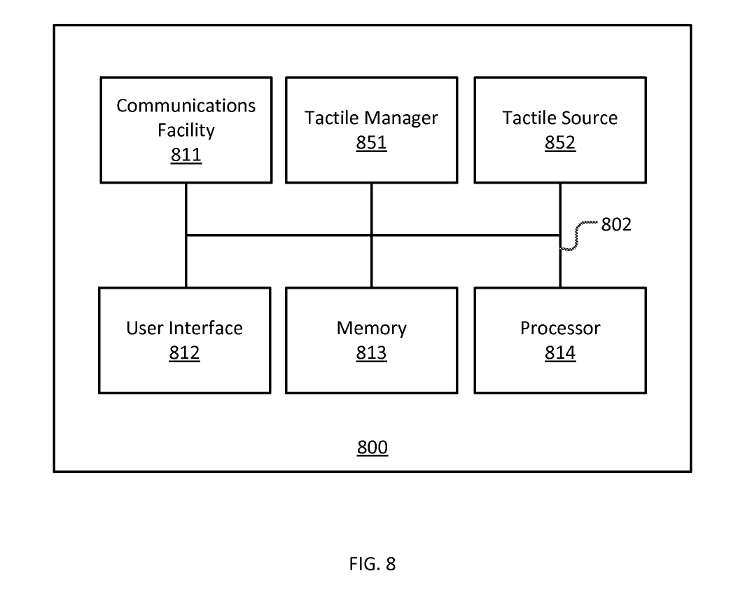

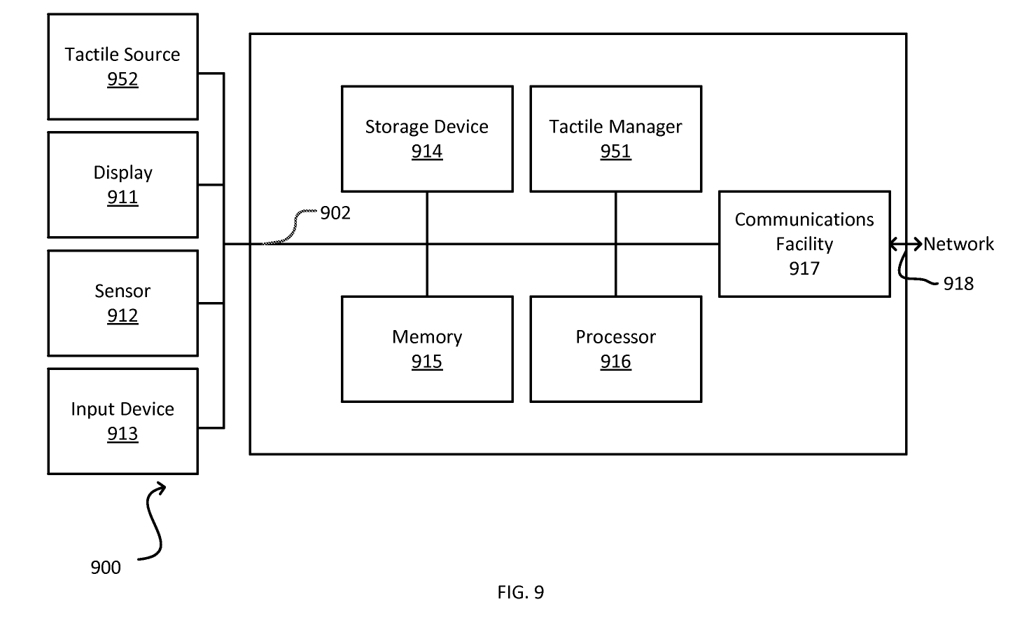

FIG. 8 illustrates a block diagram for an exemplary wearable device with a tactile manager, according to some examples. As shown, wearable device 800 includes bus 802, communications facility 811, tactile manager 851, tactile source 852, user interface 812, memory 813 and processor 814. Wearable device 800 may be a strapband, smartphone, headset, laptop, cheststrap or other device. One or more elements (communications facility 811, tactile manager 851, tactile source 852, user interface 812, memory 813 and processor 814) may be installed or manufactured locally on wearable device 800 or may be remote from wearable device 800. The elements may also be separate (as shown) or integrated. In some examples, the quantity, type, function, structure and configuration of wearable device 800 and the elements (e.g., communications facility 811, tactile manager 851, tactile source 852, user interface 812, memory 813 and processor 814) shown may be varied and are not limited to the examples provided.

As shown, processor 814 may be implemented as logic to provide control functions and signals to other elements (e.g., communications facility 811, tactile manager 851, tactile source 852, user interface 812, memory 813, etc.). Processor 814 may be implemented using any type of processor or microprocessor suitable for packaging within wearable device 800, such as a headset, data-capable strapband, or smartphone. Data processed by processor 814 may be stored using, for example, memory 813. For example, data representing a state received at a second wearable device may be stored in memory 814 of the second wearable device.

In some examples, memory 814 may be implemented using various types of data storage technologies and standards, including without limitation read-only memory (ROM), random access memory (RAM), dynamic random access memory (DRAM), static random access memory (SRAM), static/dynamic random access memory (SDRAM), magnetic random access memory (MRAM), solid state, two and three-dimensional memories, Flash® and others. Memory 814 may also be implemented using one or more partitions that are configured for multiple types of data storage technologies to allow for non-modifiable (i.e. by a user) software to be installed (e.g., firmware installed on ROM) while also providing for storage of captured data and application using, for example, RAM. Once captured and/or stored in memory 814, data may be subject to various operations performed by other elements of wearable device 800.

Data may be exchanged, transferred or otherwise communicated between a first wearable device and a second wearable device through communications facility 811. As used herein, “facility” refers to any, some or all of the features and structures that are used to implement a given set of functions. Data saved on a computer, hub or server or another wearable device or device (e.g., criteria for providing a prompt, criteria for a gesture, etc.) may also be communicated through a network with communications facility 811. For example, communications facility 811 may include a wireless radio, control circuit or logic, antenna, transceiver, receiver, transmitter, resistors, diodes, transistors or other elements that are used to transmit or receive data to and from wearable device 800. In some examples, communications facility 811 may be implemented to provide a wired data communication capability such as an analog or digital attachment, plug, jack, land line or the like to allow for data to be transferred. In other examples, communications facility 811 may be implemented to provide wireless data communication capability to transmit digitally encoded data across one or more frequencies using various types of data communication protocols, without limitation.

User interface 812 may be implemented as a touchscreen, keyboard, mouse, joystick, LED light, display screen, vibration source, motor or other device used to serve as an interface between wearable device 800 and the user. For example, user interface 812 may be used to present information to the user indicating that the user has received a tactile stimulus. As another example, user interface 812 may also be used to provide a prompt to a first wearable device, reminding the first user to send a tactile stimulus to a second user. User interface 812 may also be used to receive data manually entered by the user. The data entered using user interface 812 may be used to specify or define a gesture, criteria for a prompt, criteria for a Do Not Disturb mode, or other information. In some examples, user interface 812 may also serve as a sensor. For example, a touchscreen may be used to detect the temperature of a user's figure.

Tactile manager 851 may be used to receive a state of a first user or a force exerted on a first wearable device, generate a control signal, and cause a tactile stimulus or second force on a second wearable device, using the processes described above. Tactile manager 851 may be implemented or installed as part of or separate from processor 814. Tactile manager 851 may be stored partially or wholly on memory 813 or may be stored remotely from wearable device 800.

Tactile source 852 may be used to cause a tactile stimulus or a second force to be transmitted to a region exterior to the second wearable device, using the processes described above. Tactile source 852 may be implemented or installed as part of or separate from processor 814 or tactile manager 851. Tactile source 852 may be located locally on the second wearable device, or may be remote from the second wearable device (e.g., on another wearable device). A remote tactile source may communicate with the second wearable device using communications facility 811. The examples provided are not intended to be limiting as to the quantity or type of tactile source implemented.

Wearable device 800 may also have one or more sensors (not shown), as described above. For example, wearable device 800 may have an accelerometer, GPS/location sensor, piezoelectric sensor, etc. Sensors may be used as input sources for data captured by wearable device 800. The examples provided are not intended to be limiting as to the quantity or type of sensor implemented. In still other examples, wearable device 800 and the above-described elements may be varied in function, structure, configuration or implementation and are not limited to those shown or described.

FIG. 9 illustrates an exemplary computer system suitable for use with a tactile manager, according to some examples. Here, computer system 900 may be used to implement computer programs, applications, methods, processes, or other software to perform the above-described techniques. Computer system 900 may include bus 902, tactile source 952, display 911, sensor 912, input device 913 (e.g., keyboard, mouse or touchscreen), storage device 914, tactile manager 951, memory 915 (e.g., ROM, RAM, magnetic or optical drives), processor 916, communications facility 1245 (e.g., modem or Ethernet card), and communication link 918.

According to some examples, computer system 900 performs specific operations by processor 916 executing one or more sequences of one or more instructions stored in memory 915. Such instructions may be read into memory 915 from another computer readable medium, such as storage device 914. In some examples, hard-wired circuitry may be used in place of or in combination with software instructions for implementation. Tactile manager 951 may be implemented as part of or separate from processor 916, and tactile manager 951 may be stored partially or wholly on memory 915 or storage device 914 or another medium.

The term “computer readable medium” refers to any tangible medium that participates in providing instructions to processor 916 for execution. Such a medium may take many forms, including but not limited to, non-volatile media and volatile media. Non-volatile media includes, for example, optical or magnetic disks. Volatile media includes dynamic memory.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1202 for transmitting a computer data signal.

In some examples, execution of the sequences of instructions may be performed by a single computer system 900. According to some examples, two or more computer systems 900 coupled by communication link 918 (e.g., LAN, PSTN, or wireless network) may perform the sequence of instructions in coordination with one another. Computer system 900 may transmit and receive messages, data, and instructions, including program, i.e., application code, through communication link 918 and communication facility 917. Received program code may be executed by processor 916 as it is received, and/or stored in storage device 914 or memory 915, or other non-volatile storage for later execution.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving at a second wearable device a signal representing a state of a user of a first wearable device;
generating a control signal based on the state, the control signal configured to generate a tactile stimulus on the second wearable device; and
causing the tactile stimulus to be transmitted to a region exterior to the second wearable device.

2. The method of claim 1, wherein the tactile stimulus comprises a vibratory pattern associated with a location of the first wearable device with respect to the second wearable device.

3. The method of claim 1, wherein the tactile stimulus comprises a pressure pattern associated with a heart rate of the user.

4. The method of claim 1, wherein the state is associated with a temperature, and the tactile stimulus comprises heating of a heating element coupled to the second wearable device.

5. The method of claim 1, wherein the tactile stimulus is a simulation of the state.

6. The method of claim 1, wherein the receiving a signal representing the state of the user of the first wearable device is based on a detection of a gesture by the first wearable device.

7. The method of claim 1, further comprising transmitting a signal configured to provide a prompt on the first wearable device.

8. The method of claim 7, further comprising:
receiving one or more inputs from one or more sensors coupled to the second wearable device; and
determining a match between the one or more inputs and one or more prompt criteria stored in a memory.

9. The method of claim 8, wherein the one or more prompt criteria comprise data representing a depressed state.

10. The method of claim 1, wherein the state comprises a heart rate above 100 bpm.

11. The method of claim 1, wherein the state comprises a temperature above 100 degrees Fahrenheit.

12. A method, comprising:
receiving at a second wearable device a signal representing a first attribute of a first force from one or more sensors associated with a first wearable device;
generating a control signal based on the first attribute, the control signal configured to generate a second force on the second wearable device, the second force having a second attribute that is substantially similar to the first attribute; and
causing the second force to be transmitted to a region external to the second wearable device.

13. The method of claim 12, wherein the first force comprises a compression and the second force comprises a compression.

14. The method of claim 12, wherein the first wearable device comprises a first band, the second wearable device comprises a second band, the first attribute is a direction of the first force going inward from a circumference of the first band, and the second attribute is a direction of the second force going inward from a circumference of the second band.

15. The method of claim 12, wherein the first force comprises a first pressure pattern and the second force is substantially similar to a portion of the first pressure pattern.

16. The method of claim 12, wherein the second force is a simulation of the first force.

17. The method of claim 12, further comprising imparting the second force upon a surface of a tissue of a user wearing the second wearable device.

18. The system of claim 12, further comprising determining the second wearable device is not in a Do Not Disturb mode.

19. The system of claim 18, further comprising:
receiving one or more inputs from another one or more sensors coupled to the second wearable device; and
comparing the one or more inputs to one or more Do Not Disturb criteria stored in a memory to determine whether to set the Do Not Disturb Mode.

20. The system of claim 12, further comprising causing a visual presentation on a user interface coupled to the second wearable device based on the control signal.
